(19) United States
(12) Patent Application Publication
(10) Pub. No.: US 2026/0094619 A1
(43) Pub. Date: Apr. 2, 2026

(54) GENERATIVE AI-ASSISTED VIDEO EDITING SYSTEM AND METHOD

(71) Applicant: Atlassian US, Inc., San Francisco, CA (US)

(72) Inventors: Joe Thomas, Atlanta, GA (US); Justin Reidy, Burlington, VT (US); Rajiv Sancheti, San Francisco, CA (US); Sean Thompson, Boulder, CO (US); Luis Ramirez, Brooklyn, NY (US); Jiawei Ou, Bellevue, WA (US); Vishal Santoshi, Brooklyn, NY (US); Laura Barrera Forero, San Francisco, CA (US); Todd Bracken, Denver, CO (US)

(21) Appl. No.: 19/335,642

(22) Filed: Sep. 22, 2025

Related U.S. Application Data
(60) Provisional application No. 63/699,951, filed on Sep. 27, 2024.

(51) Int. Cl. G11B 27/031; G06F 3/04845; G10L 15/26

(52) U.S. Cl. CPC G11B 27/031; G06F 3/04845; G10L 15/26

(57) ABSTRACT

The present disclosure provides a video recording apparatus comprising at least one processor and a memory storing instructions that, when executed, cause the apparatus to receive a recorded video object configured to cause playback of a video recording of at least one speaker, generate a transcript of the video recording, cause rendering of a video edit prompt interface to a display of a client device, receive video edit instructions following user interaction with the video edit prompt interface, identify a replacement portion of the recorded video object based on the video edit instructions, generate an alternate video segment using a video segment replacement model, and generate an updated recorded video object that includes the alternate video segment in place of the replacement portion. The apparatus enables efficient editing and personalization of video recordings using generative AI techniques.

### CROSS-REFERENCE TO RELATED APPLICATIONS

This application claims the benefit of U.S. Provisional Patent Application No. 63/699,951, entitled GENERATIVE AI-ASSISTED VIDEO EDITING SYSTEM AND METHOD, which was filed Sep. 27, 2024, the entire contents of which are hereby incorporated by reference in its entirety.

### FIELD OF THE INVENTION

The present disclosure relates to video editing systems, and more particularly to a generative artificial intelligence assisted (AI-assisted) video editing system for automatically generating customized or personalized video content.

### BACKGROUND

Video editing and customization have become increasingly important in various fields, including marketing, education, and personal communication. As the demand for personalized video content grows, Applicant has identified a need for efficient and user-friendly tools that can streamline the video editing process. Some undesirable video editing methods may require significant time, technical expertise, and resources to create customized content for different audiences or purposes. Additionally, methods that require manual editing of video recordings can be prone to errors and inconsistencies, particularly when dealing with large volumes of content or complex edits.

### OVERVIEW

The present disclosure relates to systems and methods for generative AI-assisted video editing. The systems and methods described herein enable efficient error correction, editing, customization, and personalization of video content through automated editing processes that leverage generative artificial intelligence models.

In various embodiments, a video editing apparatus receives a recorded video object containing a video recording of at least one speaker. The term speaker as used herein refers to any source of speech within a video recording that may be used to generate a transcript. The apparatus generates a transcript of the video recording and renders a video edit prompt interface to a client device display. Through this interface, a user can provide video edit instructions, such as selecting portions of the transcript that contain errors or specifying replacement terms.

Based on the user's edit instructions, the apparatus identifies a replacement portion of the recorded video object. A video segment replacement model, which may include generative AI components, is then used to generate an alternate video segment. This alternate video segment is designed to seamlessly replace the identified portion while maintaining continuity with the rest of the video.

The apparatus creates an updated recorded video object by removing the replacement portion through a video trimming process and appending the alternate video segment using a video stitching process. This results in a customized video that incorporates the user-specified edits while preserving the overall quality and coherence of the original recording. Indeed, the updated recorded video object is configured, when played by a client device, to appear to a viewer as an original video recording but with the originally recorded speaker seamlessly speaking new words based on the user-specified edits. This new content matches the speaker's appearance, facial expressions, and voice patterns.

Various non-limiting example advantages of the disclosed systems and methods include: 1. Efficient editing to correct errors or personalization of video content without requiring re-recording; 2. Seamless integration of AI-generated video segments; 3. User-friendly editing through transcript-based selection; 4. Maintenance of video quality and continuity in edited content; and/or 5. Scalable customization for multiple recipients or use cases.

The generative AI-assisted video editing system provides an improved tool for creating tailored video content quickly and easily, with applications in areas such as personalized marketing, customized training materials, and individualized communications.

### BRIEF DESCRIPTION OF FIGURES

Having thus described embodiments of the invention in general terms, reference will now be made to the accompanying drawings, which are not necessarily drawn to scale. Dashed lines are used in the foregoing drawings, in some embodiments, to illustrate optional components, services, operations, or process steps.

FIG. 1 illustrates a block diagram of a generative AI-assisted video editing system, according to aspects of the present disclosure.

FIG. 2 illustrates a recorded video management interface for a generative AI-assisted video editing system, according to an embodiment.

FIG. 3 illustrates a transcript interface for a generative AI-assisted video editing system, according to aspects of the present disclosure.

FIG. 4 illustrates an editor instructions interface for a generative AI-assisted video editing system, according to an embodiment.

FIG. 5 illustrates a replacement term selector interface for a generative AI-assisted video editing system, according to aspects of the present disclosure.

FIG. 6 illustrates a sequence diagram of a video editing process using a generative AI-assisted video editing system, according to an embodiment.

### DETAILED DESCRIPTION

The present disclosure provides systems and methods for video editing that leverage generative artificial intelligence (AI) models. These systems and methods enable efficient error correction, editing, customization, and personalization of video content through automated editing processes. In various embodiments, a video recording apparatus receives a recorded video object containing a video recording of at least one speaker.

The video editing apparatus generates a transcript of the video recording and renders a video edit prompt interface to a client device display. Through this interface, a user can provide video edit instructions, such as selecting portions of the transcript that contain errors or specifying replacement terms. Based on the user's edit instructions, the video editing apparatus identifies a replacement portion of the recorded video object.

A video segment replacement model, which may include generative AI video and audio constituent components or layers, is then used to generate an alternate video segment. This alternate segment is designed to seamlessly replace the identified replacement portion while maintaining continuity with the rest of the video recording.

The apparatus creates an updated recorded video object by removing the replacement portion through a video trimming process and appending the alternate video segment using a video stitching process. This results in a customized video (e.g., an updated recorded video object) that incorporates the user-specified edits while preserving the overall quality and coherence of the original recording. The generative AI-assisted video editing system provides a powerful tool for creating tailored video content quickly and easily, with applications in areas such as personalized marketing, customized training materials, and individualized video communications.

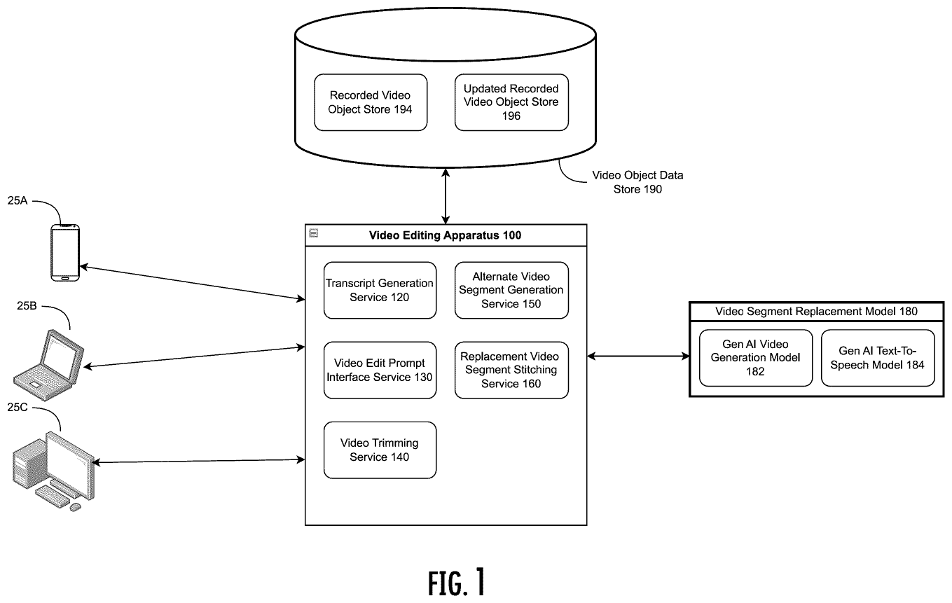

Referring to FIG. 1, the generative AI-assisted video editing system includes a video editing apparatus 100 that interacts with various client devices, such as client device 25A, client device 25B, and client device 25C. These client devices may include various types of computing devices, such as desktop computers, laptop computers, tablets, smartphones, or any other device capable of recording and playing back video content.

The video editing apparatus 100 includes at least one processor and a memory storing instructions that, when executed by the processor, enable the apparatus to perform various operations related to video editing. In some aspects, the video editing apparatus 100 receives a recorded video object from a client device. The recorded video object is configured to cause playback of a video recording of at least one speaker on the client device.

Upon receiving the recorded video object, the video editing apparatus 100 generates a transcript of the video recording based on the recorded video object. This transcript generation may be performed by a transcript generation service 120, which may utilize various speech recognition technologies to convert the audio content of the video recording into a textual format.

In some aspects, the transcript generation service 120 may utilize an instantaneous transcription process to generate the transcript in real-time as the video is being recorded or played back. This process may involve breaking the audio stream into short segments, typically lasting a few seconds each. These segments are then processed through a speech recognition model that converts the audio into text. The model may use techniques such as acoustic modeling and language modeling to accurately transcribe the speech. As each segment is transcribed, it is immediately added to the growing transcript. This approach allows for low-latency transcription, enabling near real-time availability of the transcript for editing purposes. The instantaneous transcription process may also incorporate speaker diarization to distinguish between different speakers in the video, further enhancing the usefulness of the transcript for editing tasks. An example instantaneous transcription process is disclosed in commonly owned U.S. patent application Ser. No. 18/759,644 entitled “Instantaneous Media Stream Transcription Systems and Methods”, which was filed Jun. 28, 2024 and is hereby incorporated by reference in its entirety.

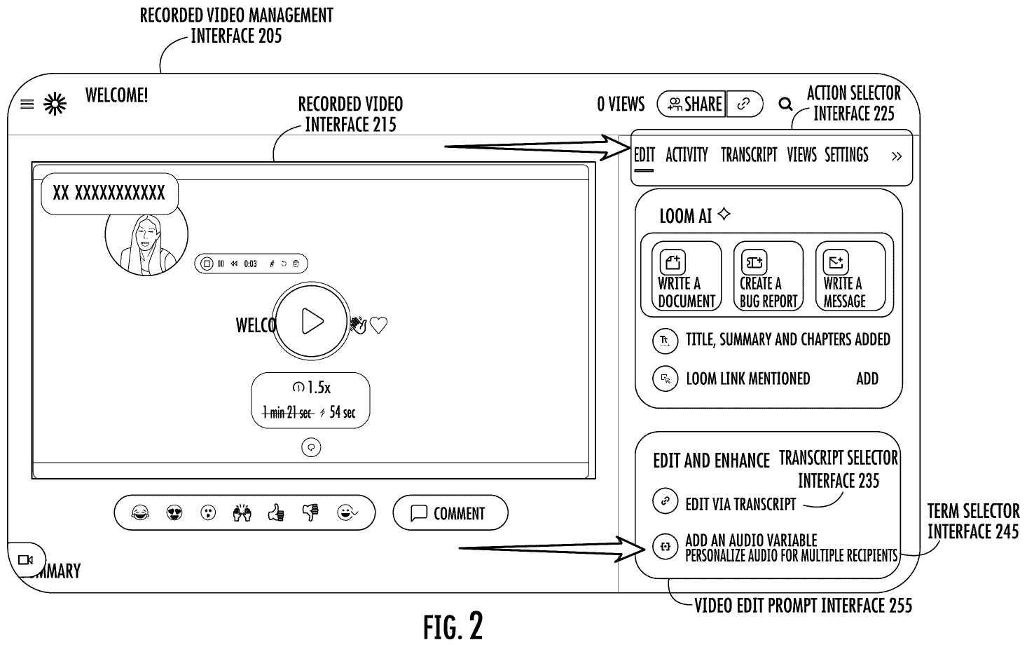

The video editing apparatus 100 also includes a video edit prompt interface service 130, which is configured to cause rendering of a video edit prompt interface (as shown in FIG. 2) on a display of the client device. This video edit prompt interface allows the user to interact with the system and provide video edit instructions. These instructions may include, for example, identifying portions of the video or the transcript to be edited or replaced.

Based on the received video edit instructions, the video editing apparatus 100 identifies a replacement portion of the recorded video object. This identification process may be performed by a video trimming service 140, which is configured to identify and remove specified portions of the video content.

In some aspects, the video trimming service 140 may perform various operations to remove the identified replacement portion from the recorded video object. These operations may include:
1. Identifying the start and end points of the replacement portion based on user-selected transcript segments or time ranges received as part of the video edit instructions.
2. Extracting the audio and video data corresponding to the replacement portion.
3. Removing the extracted audio and video data from the original recorded video object.
4. Adjusting timestamps and metadata of the remaining video segments to maintain continuity as needed.
5. Performing audio crossfading at the trim points to create smooth audio transitions.
6. Reencoding the trimmed video segments to ensure consistent video quality and format throughout the edited video.
7. Generating a new container file that includes the trimmed video segments and updated metadata.

These video trimming operations may be performed in real-time or as a background process, depending on the complexity of the edit and the processing capabilities of the video editing apparatus 100. The resulting trimmed video object may then be passed to the replacement video segment stitching service 160 for integration with the alternate video segment. An example video trimming process is disclosed in commonly owned U.S. Pat. No. 11,462,247 entitled “Instant Video Trimming and Stitching and Associated Methods and Systems”, which was filed Dec. 29, 2021 and is hereby incorporated by reference in its entirety.

The video editing apparatus 100 also includes an alternate video segment generation service 150. This alternate video segment generation service 150 is configured to generate prompts or other instructions that trigger generation of an alternate video segment using a video segment replacement model 180. The video segment replacement model 180 may include a generative AI video generation model 182 and a generative AI text-to-speech model 184. In some aspects, the models may be configured to work in coordination to generate new video and audio content that embodies the alternate video segment for replacing the identified replacement portion in the recorded video object. In some embodiments, the coordination of the generative AI video generation model 182 and the generative AI text-to-speech model 184 is managed by the alternate video segment generation service 150.

The depicted video editing apparatus 100 also includes a replacement video segment stitching service 160. This replacement video segment stitching service is configured to generate an updated recorded video object that includes the alternate video segment in place of the replacement portion.

In some aspects, the replacement video segment stitching service 160 may perform various operations to integrate the alternate video segment with the remaining portions of the recorded video object. These operations may include:
1. Identifying the insertion point for the alternate video segment based on the location of the removed replacement portion using video frames and associated time stamps.
2. Adjusting the timing and duration of the alternate video segment to match the removed portion if necessary.
3. Optionally applying video transitions, such as cross-fades or wipes, at the beginning and end of the alternate video segment to create smooth visual transitions.
4. Synchronizing the audio of the alternate video segment with the surrounding audio content.
5. Performing audio mixing and level adjustment to ensure consistent volume levels throughout the stitched video.
6. Reencoding the stitched video segments to maintain consistent video quality and format.
7. Updating metadata, such as timestamps and chapter markers, to reflect the changes in the video content.
8. Generating a new container file that includes the stitched video segments and updated metadata.

The video stitching process may be performed in real-time or as a background process, depending on the complexity of the edit and the processing capabilities of the video editing apparatus 100. An example video stitching process is disclosed in commonly owned U.S. Pat. No. 11,462,247 entitled “Instant Video Trimming and Stitching and Associated Methods and Systems”, which was filed Dec. 29, 2021 and is hereby incorporated by reference in its entirety.

This updated recorded video object is then stored in a video object data store 190, which includes a recorded video object store 194 and an updated recorded video object store 196. The updated recorded video object can then be retrieved and played back on the client device, providing the user with a customized video that incorporates the specified edits. In various embodiments, the video editing apparatus 100 may operate to create multiple versions of an updated recorded video object (e.g., in circumstances where a video recording is to be personalized for 10 different target audiences) that are each stored to the video object data store 190.

In some embodiments, the generative AI video generation model 182 of the video segment replacement model 180 comprises, at least partially, a vector quantized generative adversarial network (VQGAN). The VQGAN is a type of generative AI model that is capable of generating high-quality video content based on a set of input parameters or conditions. In some aspects, the VQGAN operates in a quantized space rather than RGB space, which aids in stable learning and faster convergence. The VQGAN may be trained on video frames to learn a compact and quantized latent representation of the input data. It converts the continuous latent embeddings into quantized vectors by mapping them to entries in a codebook. For video generation, the VQGAN can take text prompts, image inputs, or other information and produce corresponding video outputs. The model may generate video frames sequentially or in parallel, synthesizing realistic motion and temporal consistency. In some cases, the VQGAN's quantized latent space allows it to capture high-level semantic and temporal features of video content, enabling coherent speaker video generation. While VQGAN models are discussed above for illustration purposes, other embodiments of the invention are not limited to use with VQGAN models as other video generation models 182 may be deployed to generate replacement video content as will be apparent to one of ordinary skill in the art.

In some aspects, the generative AI text-to-speech model 184 may perform various operations to generate speech for the alternate video segment. These operations may include:
1. Analyzing the text input corresponding to the replacement portion or new content to be added.
2. Selecting appropriate voice characteristics based on the original speaker's voice or user-specified parameters.
3. Generating synthetic speech that matches the selected voice characteristics and conveys the input text.
4. Adjusting the speech rate, pitch, and intonation to match the surrounding audio context.
5. Applying emotion and emphasis to the generated speech based on the content and context.
6. Synchronizing the generated speech with the video content, including lip movements if applicable.
7. Performing audio post-processing to ensure the generated speech blends seamlessly with the existing audio.
8. Optimizing the generated speech for clarity and naturalness using deep learning techniques.

In some embodiments, the generative AI text-to-speech model 184 of the video segment replacement model 180 may be a speech generation model such as Voicebox published by Meta™ or Soundstorm published by Google™. As will be apparent to one of ordinary skill in the art in view of this disclosure, such generative AI models are configured to perform various speech generation tasks through in-context learning. Such AI models can produce high-quality audio clips and edit pre-recorded audio while preserving the content and style of the audio. Such AI models may further be configured to enable in-context text-to-speech synthesis, allowing the models to match an audio style using a sample as short as two seconds long.

Soundstorm is another example advanced speech generation AI model that can be used in accordance with various embodiments discussed herein. Soundstorm uses a diffusion-based approach to generate speech waveforms directly, allowing for fine-grained control over speech characteristics.

Advanced speech generation models such as Voicebox and Soundstorm utilize techniques like flow matching or diffusion and are trained on diverse data to generate speech that may be more representative of real-world speech patterns. While Voicebox and Soundbox models are discussed above for illustration purposes, other embodiments of the invention are not limited to use with Voicebox or Soundbox as other generative AI text-to-speech models 184 may be deployed to generate speech as will be apparent to one of ordinary skill in the art.

The text-to-speech processes identified above in reference to the generative AI text-to-speech model 184 may be performed in coordination with the video generation processes discussed above concerning the generative AI video generation model 182 to ensure coherence between the visual and audio components of the alternate video segment. The resulting speech may be integrated into the alternate video segment, providing a seamless replacement for the original audio content. In some embodiments, the coordination and cohesion between respective audio and video outputs of the generative AI text-to-speech model 184 and the generative AI video generation model 182 are managed by the alternate video segment generation service 150.

Referring to FIG. 2, the recorded video management interface 205 is shown. This recorded video management interface 205 is supported by the video editing apparatus 100 and is configured to be displayed on a client device, such as client device 25A, client device 25B, or client device 25C. The recorded video management interface 205 provides a user-friendly environment for users to interact with the video editing apparatus 100 and manage their video recordings.

The recorded video management interface 205 includes several key components that facilitate user interaction for video editing and customization. One of these components is the recorded video interface 215, which is configured to display a video recording based on a recorded video object or an updated recorded video object. The recorded video interface 215 includes playback controls and video information such as duration and playback speed. This interface allows users to view and interact with the video recording, providing a visual representation of the video content that can be manipulated through the video editing apparatus 100.

Above the recorded video interface 215 is the action selector interface 225. This interface provides options for different actions related to the video, including “Edit”, “Activity”, “Transcript”, “Views”, and “Settings”. These options allow users to navigate between different editing and management functions, providing a versatile toolset for managing and customizing video content.

Below the recorded video interface 215 is the video edit prompt interface 255. This interface contains various editing options that are activated in response to user interaction with the “Edit” option in the action selector interface 225. For example, in some aspects, the video edit prompt interface 255 is launched in response to user interaction with the “Edit” option among the action selector interface 225.

The video edit prompt interface 255 includes a transcript selector interface 235 and a term selector interface 245. The transcript selector interface 235 is represented by the “Edit via transcript” option, allowing users to edit the video based on selecting portions of its transcript. This feature enables users to identify specific segments of the video for editing or replacement based on spoken and transcribed text, providing a high level of control over the video content.

The term selector interface 245 is shown as “Add an audio variable”, which enables users to personalize audio for multiple recipients or otherwise designate selected words as “variables” that are designated for programmatic replacement. This feature allows for the customization of audio content within the video recording, enabling the creation of personalized video messages for different recipients.

In some embodiments, the video editing apparatus 100 may receive video edit instructions following user interaction with the video edit prompt interface 255. These instructions may specify portions of the video or the transcript to be edited or replaced, or they may specify replacement terms to be inserted into the video content. Based on these instructions, the video editing apparatus 100 identifies a replacement portion of the recorded video object and generates an alternate video segment using a video segment replacement model. The alternate video segment is then integrated into the video content, replacing the identified replacement portion and creating a customized video that incorporates the user-specified edits.

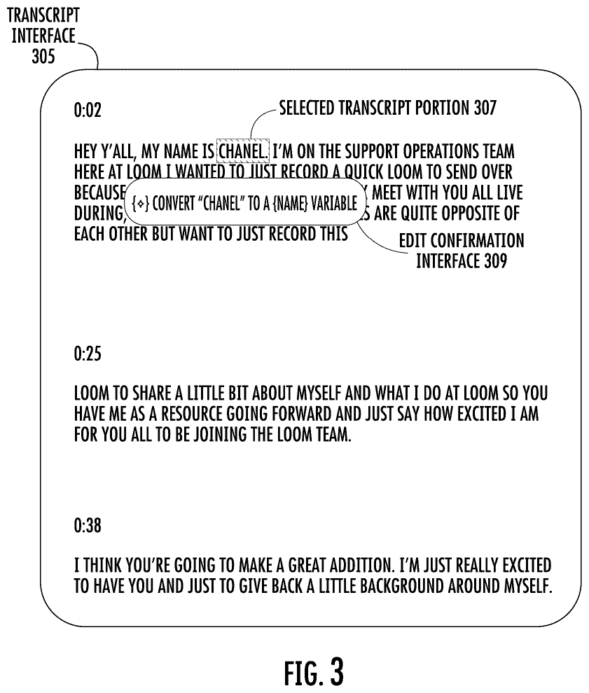

Referring to FIG. 3, the transcript interface 305 is shown. The transcript interface 305 is configured to display a transcript of a video recording, with timestamps indicating different segments of the recording. This interface provides a visual representation of the spoken content of the video, allowing users to easily identify and select specific portions of the transcript for editing.

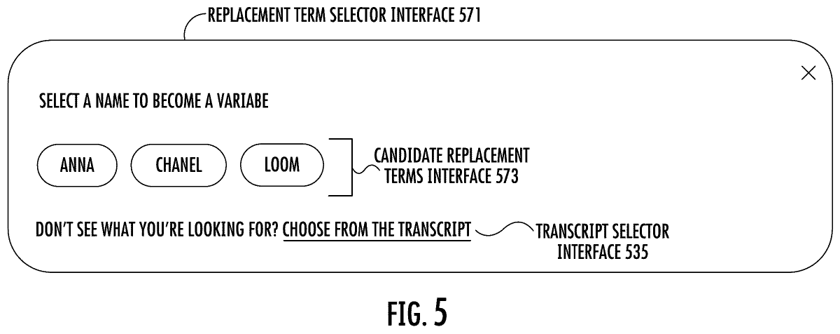

In some aspects, the transcript interface 305 is launched in response to user engagement with the transcript selector interface 235 of FIGS. 2 and/or 535 of FIG. 5. This allows users to view the transcript of the video recording and select portions of the transcript for editing. The selected portions of the transcript are highlighted in the transcript interface 305, as shown by the selected transcript portion 307. This selected transcript portion 307 represents user selection of a specific transcript portion, in this case, the name “Chanel”. In other embodiments, although not shown, portions of the transcript containing errors made during the recording may be selected as variables for replacement. For example, incorrectly spoken words or partial word utterances may be selected from the transcript as variables for replacement.

Below the selected transcript portion 307 is an edit confirmation interface 309. The edit confirmation interface 309 provides an option to convert the selected name “Chanel” to a {name} variable. This interface allows for personalization of the video by enabling the substitution of names within the transcript and corresponding audio. In error correction embodiments, terms, word fragments, or text portions other than names may be selected and designated as variables for replacement.

In some embodiments, the selection of transcript portions via the transcript interface 305 allows the video editing apparatus 100 of FIG. 1 to identify the time stamps and metadata associated with the selected transcript portions. These time stamps and metadata may form part of the video edit instructions received by the video editing apparatus from the client device(s) and, in some embodiments, inform or shape prompts provided by the alternate video segment generation service 150 to the video segment replacement model 180 (shown in FIG. 1) that trigger generation of one or more alternate video segment(s).

In some cases, the video editing apparatus may use the time stamps and metadata associated with the selected transcript portions to identify the corresponding video segments in the recorded video object. These identified video segments may then be marked as replacement portions, which are subsequently trimmed using processes discussed above and replaced with alternate video segments generated by the video segment replacement model.

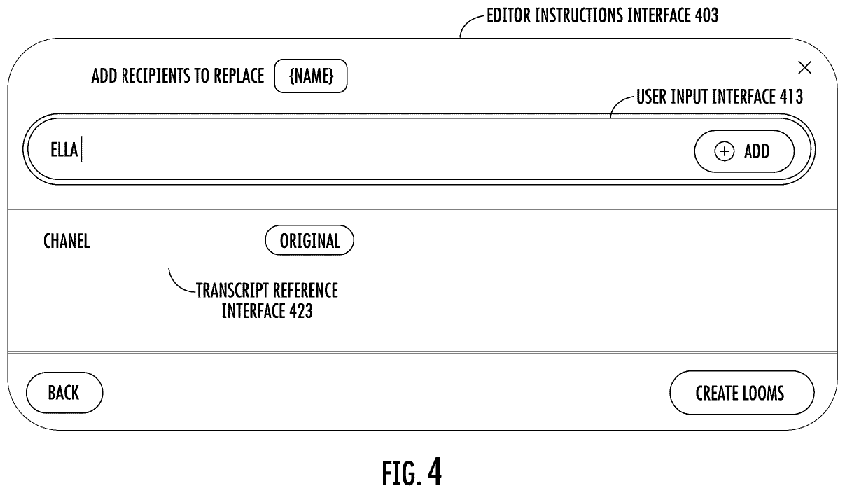

FIG. 4 illustrates an example editor instructions interface 403 supported by the video editing apparatus 100 and configured to be displayed on a client device, such as client device 25A, client device 25B, or client device 25C. In some aspects, the editor instructions interface 403 is launched in response to user engagement with the term selector interface 245 of FIG. 2. This allows users to select a term to be replaced and then specify the new term through the editor instructions interface 403. The video editing apparatus 100 receives these instructions and carries out the necessary editing operations to replace the selected term with the new term in the video content.

The depicted editor instructions interface 403 includes a user input interface 413 and a transcript reference interface 423. The user input interface 413 includes a text input field where users can enter new names or selected text terms. In this example, the name “Ella” is entered. In error correction embodiments where non-name variables are selected for replacement, other terms may be entered. An “Add” button is provided to confirm the addition of the entered name or text term. This feature allows users to specify new names or text terms that will replace the selected variable name in the video content, enabling personalization of the video.

The transcript reference interface 423 shows the original name or term, here “Chanel”, that is to be replaced, labeled as “Original”. This transcript reference interface 423 provides context for the name or term replacement operation, allowing users to see the original name or term that will be replaced with the new name or term entered in the user input interface 413.

In various embodiments, the video editing apparatus 100 is configured to use the new name or term entered in the user input interface 413 to generate an alternate video segment using the video segment replacement model. This alternate video segment includes the new name or term in place of the original name or term in the generated video and audio content. The video editing apparatus 100 then integrates this alternate video segment into the remaining portion of the original video recording, replacing the original name or term with the new name or term and creating a personalized video (e.g., an updated recorded video object) that incorporates the user-specified edits.

Referring to FIG. 5, the replacement term selector interface 571 is shown. The replacement term selector interface 571 is configured to enable users to select names or terms for personalization of video content. In some aspects, the replacement term selector interface 571 is launched in response to a user adding one or more names or terms using the user input interface 413 of the editor instructions interface 403 of FIG. 4.

The replacement term selector interface 571 depicted in FIG. 5 includes a candidate replacement terms interface 573, which displays three selectable options: “Anna”, “Chanel”, and “Loom”. These options represent potential names that can be converted into variables for personalization of the video recording. In some embodiments, one or more terms listed in the term selector interface may be programmatically determined upon parsing a video recording transcript based on predefined rules (e.g., names, teams, towns, other predefined categories) without manual adding by a user via the user input interface 413 of the editor instructions interface 403 of FIG. 4.

Below the candidate replacement terms interface 573 in the example shown in FIG. 5 is a transcript selector interface 535. This transcript selector interface 535 provides an option for users to choose a name or term directly from the video transcript if a desired name, term, or phrase is not present in the candidate replacement terms interface 573. In the depicted example, the transcript selector interface 535 is represented by the text “Don't see what you're looking for? Choose from the transcript”, with “Choose from the transcript” appearing as a clickable link.

In some embodiments, the video editing apparatus 100 is configured to receive video edit instructions from the client device(s) 25A-C following user interaction with the replacement term selector interface 571. These video edit instructions may specify one or more replacement terms to be inserted into the video content. The video edit instructions may also include time stamps, metadata, video frame identifiers, and other information that enables the video editing apparatus 100 to identify a replacement portion of the recorded video object and to cause generation of an alternate video segment using a video segment replacement model.

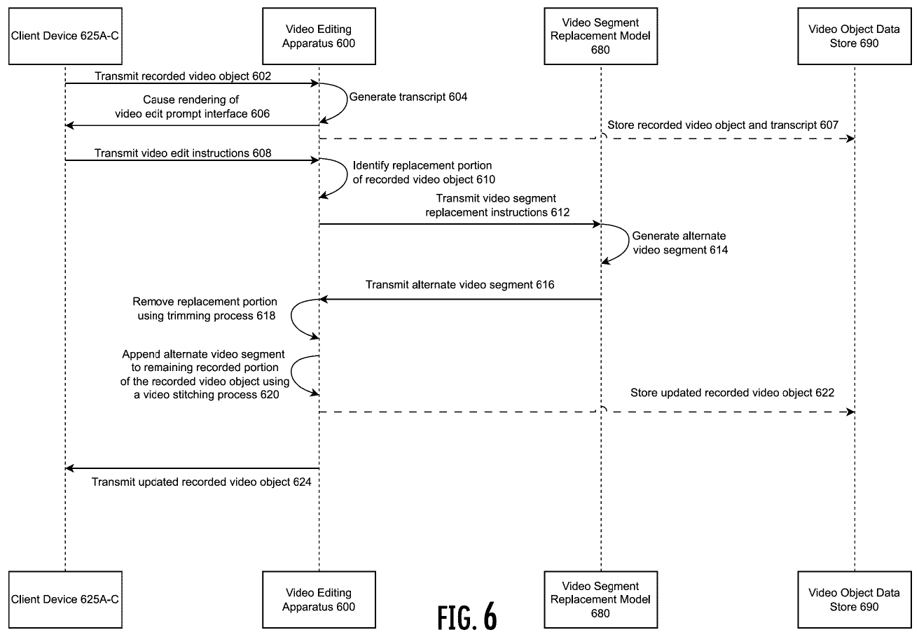

Referring to FIG. 6, the sequence diagram illustrates the process of video editing using a generative AI-assisted video editing system. The process involves four main components: client device 625A-C, video editing apparatus 600, video segment replacement model 680, and video object data store 690.

At step 602, the client device 625A-C transmits a recorded video object to the video editing apparatus 600. The recorded video object is configured to cause playback of a video recording of at least one speaker on the client device. Upon receiving the recorded video object, the video editing apparatus 600, through its transcript generation service 120 (shown in FIG. 1), generates a transcript of the video recording based on the recorded video object at step 604. In some embodiments, the video editing apparatus 600 may optionally store the recorded video object and transcript to the video object data store at step 607. The stored recorded video object may be useful in circumstances where a user wishes to revert back from an updated recorded video object to an original version of the recorded video. The stored recorded video object may also be fetched from the video object data store (rather than being directly received from the client device 625A-C) for editing or re-editing.

The video editing apparatus 600, through its video edit prompt interface service 130 (shown in FIG. 1), then causes rendering of a video edit prompt interface on a display of the client device 625A-C at step 606. This interface allows the user to interact with the system and provide video edit instructions.

At step 608, the video editing apparatus 600 receives video edit instructions following user interaction with the video edit prompt interface. These instructions may include, for example, identifying portions of the video or the transcript to be edited or replaced, or they may specify replacement terms to be inserted into the video content.

Based on these instructions, the video editing apparatus 600, through its video trimming service 140 (shown in FIG. 1), identifies a replacement portion of the recorded video object at step 610. This identification process may involve locating the specified portions of the video or transcript within the recorded video object and marking them for replacement.

The video editing apparatus 600, through its alternate video segment generation service 150 (shown in FIG. 1), then transmits video segment replacement instructions to the video segment replacement model 680 at step 612. These instructions may include the identified replacement portion, the specified replacement terms, appropriate generative AI prompts, and other relevant information.

In response to these instructions, the video segment replacement model 680 generates an alternate video segment at step 614. This alternate video segment is designed to replace the identified replacement portion in the video recording. The video segment replacement model 680 then transmits the alternate video segment back to the video editing apparatus 600 at step 616.

Upon receiving the alternate video segment, the video editing apparatus 600, through its video trimming service 140, removes the identified replacement portion from the recorded video object at step 618. This removal process may involve deleting the corresponding video and audio data from the recorded video object.

The video editing apparatus 600, through its replacement video segment stitching service 160, then appends the alternate video segment to the remaining recorded portion of the recorded video object at step 620. This stitching process may involve adjusting the timing and duration of the alternate video segment to match the removed portion and integrating the alternate video segment into the video content.

The video editing apparatus 600 then optionally stores the updated recorded video object in the video object data store 690 at step 622. This updated recorded video object includes the alternate video segment in place of the replacement portion, resulting in a customized video that incorporates the user-specified edits.

Finally, at step 624, the video editing apparatus 600 transmits the updated recorded video object back to the client device 625A-C. This allows the user to view the edited video recording on the client device. The updated recorded video object can be played back on the client device, providing the user with a customized video that incorporates the specified edits.

In some embodiments, the video editing apparatus 600 may operate to create multiple versions of an updated recorded video object (e.g., in circumstances where a video recording is to be personalized for multiple different target audiences) that are each stored to the video object data store 690.

The terms “client device”, “computing device”, “user device”, and the like may be used interchangeably to refer to computer hardware that is configured (either physically or by the execution of software) to access one or more of an application, service, or repository made available by a server (e.g., apparatus of the present disclosure) and, among various other functions, is configured to directly, or indirectly, transmit and receive data. The server is often (but not always) on another computer system, in which case the client device accesses the service by way of a network. Example client devices include, without limitation, smart phones, tablet computers, laptop computers, wearable devices (e.g., integrated within watches or smartwatches, eyewear, helmets, hats, clothing, earpieces with wireless connectivity, and the like), personal computers, desktop computers, enterprise computers, the like, and any other computing devices known to one skilled in the art in light of the present disclosure.

The terms “data,” “content,” “digital content,” “digital content object,” “signal,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

The term “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media.

Examples of non-transitory computer-readable media include a magnetic computer readable medium (e.g., a floppy disk, hard disk, magnetic tape, any other magnetic medium), an optical computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use computer-readable storage medium, other types of computer-readable mediums can be substituted for or used in addition to the computer-readable storage medium in alternative embodiments.

The terms “application,” “software application,” “app,” “product,” “service” or other similar terms refer to a computer program or group of computer programs designed to perform coordinated functions, tasks, or activities for the benefit of a user or group of users. A software application can run on a server or group of servers (e.g., physical or virtual servers in a cloud-based computing environment). In certain embodiments, an application is designed for use by and interaction with one or more local, networked or remote computing devices, such as, but not limited to, client devices. Non-limiting examples of an application comprise project management, workflow engines, service desk incident management, team collaboration suites, cloud services, word processors, spreadsheets, accounting applications, web browsers, email clients, media players, file viewers, videogames, audio-video conferencing, and photo/video editors. In some embodiments, an application is a cloud product.

The terms “machine learning module,” “machine learning model,” “ML model(s)”, or “artificial intelligence model(s)” refer to a machine learning or deep learning task or algorithm. The term “machine learning” refers to a method used to devise complex models and algorithms that lend themselves to prediction or content generation. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, or the like.

A machine learning model is initially fit or trained on a training dataset (e.g., a set of examples used to fit the parameters of the model). The model may be trained on the training dataset using supervised or unsupervised learning. The model is run with the training dataset and produces a result, which is then compared with a target, for each input vector in the training dataset. Based on the result of the comparison and the specific learning algorithm being used, the parameters of the model are adjusted.

The machine learning models as described herein may make use of multiple ML engines (e.g., for analysis, transformation, and other needs). The system may train different ML models for different needs and different ML-based engines. The system may generate new models (based on the gathered training data) and may evaluate their performance against the existing models. Training data may include any of the gathered information, as well as information on actions performed based on the various recommendations.

The ML models may be any suitable model for the task or activity implemented by each ML-based engine. Machine learning models may be some form of neural network. The underlying ML models may be learning models (supervised or unsupervised). As examples, such algorithms may be prediction (e.g., linear regression) algorithms, classification (e.g., decision trees) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders), speech-to-text models, or generative models (e.g., GANs).

The ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks or VQGAN models).

In various embodiments, the ML models may undergo a training or learning phase before they are released into a production or runtime phase or may begin operation with models from existing systems or models. During a training or learning phase, the ML models may be tuned to focus on specific variables, to reduce error margins, or to otherwise optimize their performance. The ML models may initially receive input from a wide variety of data, such as the gathered data described herein. The ML models herein may undergo a second or multiple subsequent training phases for retraining the models.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The terms “illustrative,” “example,” “exemplary” and the like are used herein to mean “serving as an example, instance, or illustration” with no indication of quality level. Any implementation described herein as “exemplary” is not necessarily to be construed as preferred or advantageous over other implementations.

The phrases “in one embodiment,” “according to one embodiment,” “in one aspect”, and the like generally mean that the particular feature, structure, or characteristic following the phrase may be included in the at least one embodiment of the present invention and may be included in more than one embodiment of the present invention (importantly, such phrases do not necessarily refer to the same embodiment).

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The term “plurality” refers to two or more items.

The term “set” refers to a collection of one or more items.

The term “or” is used herein in both the alternative and conjunctive sense, unless otherwise indicated.

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.

Clause 1. An apparatus comprising at least one processor and a memory storing instructions that are operable, when executed by the processor, to cause the apparatus to: receive a recorded video object that is configured to cause playback, on a client device, of a video recording of at least one speaker; generate a transcript of the video recording based on the recorded video object; cause rendering of a video edit prompt interface to a display of the client device; receive video edit instructions following user interaction with the video edit prompt interface; identify a replacement portion of the recorded video object based on the video edit instructions; generate an alternate video segment using a video segment replacement model; and generate an updated recorded video object that includes the alternate video segment in place of the replacement portion.

Clause 2. The apparatus of Clause 1, wherein the replacement portion of the recorded video object is removed by a video trimming process.

Clause 3. The apparatus of any of the aforementioned Clauses, wherein the alternate video segment is appended to a remaining recorded portion of the recorded video object by a video stitching process when generating the updated recorded video object.

Clause 4. The apparatus of any of the aforementioned Clauses, wherein the video segment replacement model comprises a generative artificial intelligence video generation model.

Clause 5. The apparatus of any of the aforementioned Clauses, wherein the generative artificial intelligence video generation model is a vector quantized generative adversarial network.

Clause 6. The apparatus of any of the aforementioned Clauses, wherein the video segment replacement model comprises a generative artificial intelligence video generation model and a text to speech generative artificial intelligence model.

Clause 7. The apparatus of any of the aforementioned Clauses, wherein the video edit prompt interface is configured to enable user selection of at least a portion of the transcript of the video recording to define the video edit instructions.

Clause 8. The apparatus of any of the aforementioned Clauses, wherein the video edit prompt interface is configured to enable user selection of one or more replacement terms to define the video edit instructions.

Clause 9. A method comprising: receiving a recorded video object configured to cause playback of a video recording of at least one speaker; generating a transcript of the video recording based on the recorded video object; causing rendering of a video edit prompt interface on a display; receiving video edit instructions based on user interaction with the video edit prompt interface; identifying a replacement portion of the recorded video object based on the video edit instructions; generating an alternate video segment using a video segment replacement model; and creating an updated recorded video object by appending the alternate video segment to a remaining recorded portion of the recorded video object in place of the identified replacement portion.

Clause 10. The method of any of the aforementioned Clauses, wherein the replacement portion of the recorded video object is removed by a video trimming process.

Clause 11. The method of any of the aforementioned Clauses, wherein the alternate video segment is appended to the remaining recorded portion of the recorded video object by a video stitching process when creating the updated recorded video object.

Clause 12. The method of any of the aforementioned Clauses, wherein the video segment replacement model comprises a generative artificial intelligence video generation model.

Clause 13. The method of any of the aforementioned Clauses, wherein the generative artificial intelligence video generation model is a vector quantized generative adversarial network.

Clause 14. The method of any of the aforementioned Clauses, wherein the video segment replacement model comprises a generative artificial intelligence video generation model and a text to speech generative artificial intelligence model.

Clause 15. The method of any of the aforementioned Clauses, wherein the video edit prompt interface is configured to enable user selection of at least a portion of the transcript of the video recording to define the video edit instructions.

Clause 16. The method of any of the aforementioned Clauses, wherein the video edit prompt interface is configured to enable user selection of one or more replacement terms to define the video edit instructions.

Clause 17. A non-transitory computer-readable medium storing instructions that, when executed by at least one processor, cause the at least one processor to perform operations comprising: receiving a recorded video object that is configured to cause playback, on a client device, of a video recording of at least one speaker; generating a transcript of the video recording based on the recorded video object; causing rendering of a video edit prompt interface to a display of the client device; receiving video edit instructions following user interaction with the video edit prompt interface; identifying a replacement portion of the recorded video object based on the video edit instructions; generating an alternate video segment using a video segment replacement model; and generating an updated recorded video object that includes the alternate video segment in place of the replacement portion.

Clause 18. The non-transitory computer-readable medium of any of the aforementioned Clauses, wherein the replacement portion of the recorded video object is removed by a video trimming process.

Clause 19. The non-transitory computer-readable medium of any of the aforementioned Clauses, wherein the alternate video segment is appended to a remaining recorded portion of the recorded video object by a video stitching process when generating the updated recorded video object.

Clause 20. The non-transitory computer-readable medium of any of the aforementioned Clauses, wherein the video segment replacement model comprises a generative artificial intelligence video generation model.

Clause 21. The non-transitory computer-readable medium of any of the aforementioned Clauses, wherein the generative artificial intelligence video generation model is a vector quantized generative adversarial network.

Clause 22. The non-transitory computer-readable medium of any of the aforementioned Clauses, wherein the video segment replacement model comprises a generative artificial intelligence video generation model and a text to speech generative artificial intelligence model.

Clause 23. The non-transitory computer-readable medium of any of the aforementioned Clauses, wherein the video edit prompt interface is configured to enable user selection of at least a portion of the transcript of the video recording to define the video edit instructions.

Clause 24. The non-transitory computer-readable medium of any of the aforementioned Clauses, wherein the video edit prompt interface is configured to enable user selection of one or more replacement terms to define the video edit instructions.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A video recording apparatus comprising at least one processor and a memory storing instructions that are operable, when executed by the processor, to cause the apparatus to:
receive a recorded video object that is configured to cause playback, on a client device, of a video recording of at least one speaker;
generate a transcript of the video recording based on the recorded video object;
cause rendering of a video edit prompt interface to a display of the client device;
receive video edit instructions following user interaction with the video edit prompt interface;
identify a replacement portion of the recorded video object based on the video edit instructions;
generate an alternate video segment using a video segment replacement model; and
generate an updated recorded video object that includes the alternate video segment in place of the replacement portion.

2. The video recording apparatus of claim 1, wherein the replacement portion of the recorded video object is removed by a video trimming process.

3. The video recording apparatus of claim 1, wherein the alternate video segment is appended to a remaining recorded portion of the recorded video object by a video stitching process when generating the updated recorded video object.

4. The video recording apparatus of claim 1, wherein the video segment replacement model comprises a generative artificial intelligence video generation model.

5. The video recording apparatus of claim 4, wherein the generative artificial intelligence video generation model is comprised at least partially of a vector quantized generative adversarial network.

6. The video recording apparatus of claim 1, wherein the video segment replacement model comprises a generative artificial intelligence video generation model and a text to speech generative artificial intelligence model.

7. The video recording apparatus of claim 1, wherein the video edit prompt interface is configured to enable user selection of at least a portion of the transcript of the video recording to define the video edit instructions.

8. The video recording apparatus of claim 1, wherein the video edit prompt interface is configured to enable user selection of one or more replacement terms to define the video edit instructions.

9. A method for editing video recordings, comprising:
receiving a recorded video object configured to cause playback of a video recording of at least one speaker;
generating a transcript of the video recording based on the recorded video object;
causing rendering of a video edit prompt interface on a display;
receiving video edit instructions based on user interaction with the video edit prompt interface;
identifying a replacement portion of the recorded video object based on the video edit instructions;
generating an alternate video segment using a video segment replacement model; and
creating an updated recorded video object by appending the alternate video segment to a remaining recorded portion of the recorded video object in place of the identified replacement portion.

10. The method of claim 9, wherein the replacement portion of the recorded video object is removed by a video trimming process.

11. The method of claim 9, wherein the alternate video segment is appended to the remaining recorded portion of the recorded video object by a video stitching process when creating the updated recorded video object.

12. The method of claim 9, wherein the video segment replacement model comprises a generative artificial intelligence video generation model.

13. The method of claim 9, wherein the video segment replacement model comprises a generative artificial intelligence video generation model and a text to speech generative artificial intelligence model.

14. The method of claim 9, wherein the video edit prompt interface is configured to enable user selection of at least a portion of the transcript of the video recording to define the video edit instructions.

15. The method of claim 9, wherein the video edit prompt interface is configured to enable user selection of one or more replacement terms to define the video edit instructions.

16. A non-transitory computer-readable medium storing instructions that, when executed by at least one processor, cause the at least one processor to perform operations comprising:
receiving a recorded video object that is configured to cause playback, on a client device, of a video recording of at least one speaker;
generating a transcript of the video recording based on the recorded video object;
causing rendering of a video edit prompt interface to a display of the client device;
receiving video edit instructions following user interaction with the video edit prompt interface;
identifying a replacement portion of the recorded video object based on the video edit instructions;
generating an alternate video segment using a video segment replacement model; and
generating an updated recorded video object that includes the alternate video segment in place of the replacement portion.

17. The non-transitory computer-readable medium of claim 16, wherein the replacement portion of the recorded video object is removed by a video trimming process.

18. The non-transitory computer-readable medium of claim 16, wherein the alternate video segment is appended to a remaining recorded portion of the recorded video object by a video stitching process when generating the updated recorded video object.

19. The non-transitory computer-readable medium of claim 16, wherein the video segment replacement model comprises a generative artificial intelligence video generation model.

20. The non-transitory computer-readable medium of claim 16, wherein the video segment replacement model comprises a generative artificial intelligence video generation model and a text to speech generative artificial intelligence model.
